(19) United States
(12) Patent Application Publication
(10) Pub. No.: US 2023/0123455 A1
(43) Pub. Date: Apr. 20, 2023

(54) NEGATIVE ELECTRODE PLATE AND LITHIUM-ION BATTERY

(71) Applicant: ZHUHAI COSMX BATTERY CO., LTD., Zhuhai (CN)

(72) Inventors: Xianfei HU, Zhuhai (CN); Zhengfa YU, Zhuhai (CN); Bo SONG, Zhuhai (CN)

(73) Assignee: ZHUHAI COSMX BATTERY CO., LTD., Zhuhai (CN)

(21) Appl. No.: 18/068,724

(22) Filed: Dec. 20, 2022

Related U.S. Application Data
(63) Continuation of application No. PCT/CN2021/105841, filed on Jul. 12, 2021.

(30) Foreign Application Priority Data
Jul. 16, 2020 (CN) 202010688051.3

(51) Int. Cl. H01M 4/36; H01M 4/04; H01M 4/38; H01M 4/583; H01M 10/0525

(52) U.S. Cl. CPC H01M 4/366; H01M 4/0404; H01M 4/364; H01M 4/386; H01M 4/583; H01M 10/0525; H01M 2004/027

(57) ABSTRACT

Disclosed are a negative electrode plate and a lithium-ion battery. The negative electrode plate includes a negative electrode current collector, a first negative electrode active material layer, and a second negative electrode active material layer. The first negative electrode active material layer is disposed on a surface of the negative electrode current collector, and the second negative electrode active material layer is disposed on a surface of the first negative electrode active material layer. The first negative electrode active material layer includes a first graphite and a first silicon material, and the second negative electrode active material layer includes a second graphite. An OI value of the first graphite is greater than an OI value of the second graphite.

### CROSS-REFERENCE TO RELATED APPLICATIONS

The present application is a continuation application of International Application No. PCT/CN2021/105841, filed on Jul. 12, 2021, which claims priority to Chinese Patent Application No. 202010688051.3, filed on Jul. 16, 2020. Both applications are incorporated herein by reference in their entireties.

### TECHNICAL FIELD

The present application belongs to the technical field of lithium-ion batteries, and specifically relates to a silicon-doped negative electrode plate and a lithium-ion battery containing the negative electrode plate.

### BACKGROUND

With the gradual improvement of people's performance requirements for electronic products such as mobile phones, laptops, etc., the rapid development of lithium-ion batteries is particularly important. Increasing an energy density of batteries without losing cycle performance has always been the goal of lithium battery workers.

In existing negative electrode coating structures of lithium-ion batteries, a single-layer coating structure is generally used. The structure is characterized by uniform distribution of the coating everywhere, but there are also some problems. Because a solid phase diffusion rate of lithium in silicon material is lower than that of graphite, that is, a lithium intercalation rate of silicon material is slower than that of graphite, a negative electrode is prone to a problem of lithium precipitation during charging when the silicon material is introduced. Therefore, it is particularly important to propose a silicon-doped negative electrode plate with higher capacity per gram of negative electrode without worsening charging performance of negative electrode.

### SUMMARY

In order to improve an energy density of a battery cell, it is an effective solution to use high capacity per gram of silicon material mixed with graphite as a main material of negative electrode. However, due to inherent properties of silicon materials, with the increase of its mixing proportion, the cycle performance of the battery cell deteriorates sharply, and an expansion rate in a cycle process increases rapidly, which has always been an industry problem to be solved urgently.

Based on the above phenomenon, according to the present application, two sides of a negative electrode current collector are respectively coated with two layers to form a first negative electrode active material layer and a second negative electrode active material layer having different compositions, by using a double-layer coating device. The first negative electrode active material layer includes a first graphite and a first silicon material, the second negative electrode active material layer includes a second graphite, so that a battery cell containing the negative electrode plate has higher energy density and cycle performance. In another aspect, graphite materials having different OI values (OI=I₀₀₄/I₁₁₀, where I₀₀₄ denotes a peak intensity of a 004 crystal plane of graphite during X-ray diffraction, and I₁₁₀ denotes a peak intensity of a 110 crystal plane of graphite during X-ray diffraction) are respectively used for the two layers of slurry. An OI value of the first graphite of the first negative electrode active material layer tightly attached to the negative electrode current collector is greater than an OI value of the second graphite of the second negative electrode active material layer far away from the negative electrode current collector. This design can effectively improve the charging capability of the negative electrode and further optimize the cycle performance of the battery cell.

The purpose of the present application is achieved through the following technical solutions:

A negative electrode plate, the negative electrode plate includes a negative electrode current collector, a first negative electrode active material layer and a second negative electrode active material layer. The first negative electrode active material layer is disposed on a surface of the negative electrode current collector, and the second negative electrode active material layer is disposed on a surface of the first negative electrode active material layer;

where the first negative electrode active material layer includes a first negative electrode active material, and the first negative electrode active material includes a first graphite and a first silicon material;

the second negative electrode active material layer includes a second negative electrode active material, and the second negative electrode active material includes a second graphite; and

an OI value of the first graphite is greater than an OI value of the second graphite; OI=I₀₀₄/I₁₁₀, where I₀₀₄ denotes a peak intensity of a 004 crystal plane of graphite during X-ray diffraction, and I₁₁₀ denotes a peak intensity of a 110 crystal plane of graphite during X-ray diffraction. The OI value represents an orientation index of graphite. The smaller the OI value of graphite, the more favorable diffusion of lithium-ions, and its ultimate compacted density decreases.

In the present application, graphite with a small OI value is used in negative electrode slurry away from the current collector, which can effectively enhance diffusion ability of lithium-ions and improve charging performance of the negative electrode. Graphite with a greater OI value is used in negative electrode slurry close to the current collector, which can increase compacted density of the negative electrode plate, thereby increasing the energy density of battery.

According to the present application, the second negative electrode active material further includes a second silicon material; and a mass proportion of the first silicon material in the first negative electrode active material layer is greater than a mass proportion of the second silicon material in the second negative electrode active material layer.

Further, in a specific implementation, the mass proportion of the first silicon material in the first negative electrode active material layer ranges from 3 wt % to 9 wt %, and the mass proportion of the second silicon material in the second negative electrode active material layer ranges from 1 wt % to 3 wt %.

In another specific implementation, the mass proportion of the first silicon material in the first negative electrode active material layer ranges from 3 wt % to 9 wt %, and the mass proportion of the second silicon material in the second negative electrode active material layer is 0.

In the above two specific implementations, since a volume of the silicon material in a process of de-intercalation of lithium-ions varies greatly, increasing a doping amount of the silicon material may cause more particles to break during the cycle, resulting in bonding and conductive failure, continuous growth of negative electrode solid electrolyte interphase (SEI), consumption of the lithium-ions and electrolyte, thickening of the negative electrode plate and shedding of the active material. The macroscopic performance is that capacity retention of the battery decays rapidly and a thickness expansion rate increases rapidly. The high mass proportion of the first silicon material may improve the energy density of the battery; and the low mass proportion of the second silicon material may ensure the charging and cycle performance of the second negative electrode active material layer of the negative electrode plate, thereby improving the cycle performance of the whole battery.

According to the present application, a sum of a mass of the first silicon material and that of the second silicon material accounts for 1 wt % to 9 wt % of a total mass of the first negative electrode active material layer and the second negative electrode active material layer.

According to the present application, a ratio of a thickness of the first negative electrode active material layer to a thickness of the second negative electrode active material layer may range from 1:9 to 9:1, e.g. 1:9, 2:8, 3:7, 4:6, 5:5, 6:4, 7:3, 8:2, 9:1. The thinner the first negative electrode active material layer and the thicker the second negative electrode active material layer, the stronger the lithium intercalation ability of the negative electrode, that is, the battery charging kinetics is enhanced, and a risk of lithium precipitation at high rate charging is reduced.

Exemplarily, the ratio of the thickness of the first negative electrode active material layer to the thickness of the second negative electrode active material layer is 5:5. The mass proportion of the first silicon material in the first negative electrode active material layer is 3%, 5%, 7% or 9%, the mass proportion of the second silicon material in the second negative electrode active material layer is 0%, 1%, 2% or 3%, and the sum of the mass of the first silicon material and that of the second silicon material accounts for 1.5%, 3%, 4.5% or 6% of the total mass of the first negative electrode active material layer and the second negative electrode active material layer.

Exemplarily, the ratio of the thickness of the first negative electrode active material layer to the thickness of the second negative electrode active material layer is 8:2. The mass proportion of the first silicon material in the first negative electrode active material layer is 3%, 5%, 7% or 9%, the mass proportion of the second silicon material in the second negative electrode active material layer is 0%, 1%, 2% or 3%, and the sum of the mass of the first silicon material and that of the second silicon material accounts for 2.4%, 4.2%, 6% or 7.8% of the total mass of the first negative electrode active material layer and the second negative electrode active material layer.

According to the present application, a thickness of the first negative electrode active material layer ranges from 20 μm to 180 μm, preferably ranges from 20 μm to 150 μm, such as 20 μm, 30 μm, 40 μm, 50 μm, 60 μm, 70 μm, 80 μm, 90 μm, 100 μm, 110 μm, 120 μm, 130 μm, 140 μm, or 150 μm; and a thickness of the second negative electrode active material layer ranges from 20 μm to 180 μm, preferably ranges from 50 μm to 180 μm, such as 50 μm, 60 μm, 70 μm, 80 μm, 90 μm, 100 μm, 110 μm, 120 μm, 130 μm, 140 μm, 150 μm, 160 μm, 170 μm, or 180 μm.

The first silicon material and/or the second silicon material may be selected from one or more of elemental silicon, silicon oxide, silicon carbon composite, and silicon alloy.

Preferably, coating treatment is performed on the first silicon material and/or the second silicon material, and a coating includes carbon material or at least one oxide of Al, Si, Ti, Mn, V, Cr, Co or Zr. It should be noted that the coating mentioned in the present application is coated on at least part of a surface of the silicon material.

According to the present application, the first silicon material and/or the second silicon material are carbon-coated elemental silicon, the carbon-coated elemental silicon has a median particle diameter D50 of 0.01 μm to 1 μm and a carbon-coated layer has a thickness ranging from 1 nm to 10 nm.

According to the present application, the first silicon material and/or the second silicon material are silicon oxide, and the silicon oxide has a median particle diameter D50 ranging from Further, the molecular formula of the silicon oxide is SiOx, where 0.5≤x≤1.5.

According to the present application, the OI value of the first graphite ranges from 5 to 7, the OI value of the second graphite ranges from 3 to 5, and the OI value of the first graphite is greater than the OI value of the second graphite.

According to the present application, an ultimate compacted density of the first graphite is greater than or equal to an ultimate compacted density of the second graphite, the ultimate compacted density refers to a maximum compacted density under the premise that graphite particles are not crushed and the ability to de-intercalate lithium is not affected.

According to the present application, the first graphite has an ultimate compacted density ranging from 1.75 g/cm³ to 1.83 g/cm³; and the second graphite has an ultimate compacted density ranging from 1.65 g/cm³ to 1.75 g/cm³.

According to the present application, the first graphite has a median particle diameter D50 ranging from 10 μm to 20 μm; and the second graphite has a median particle diameter D50 ranging from 10 μm to 20 μm.

According to the present application, a surface of the second graphite is coated with hard carbon, and a hard carbon coating has a thickness ranging from 5 nm to 20 nm.

According to the present application, the first graphite and the second graphite are the same or different, respectively and independently selected from at least one of artificial graphite, natural graphite, etc.

According to the present application, the first negative electrode active material layer further includes a first conductive agent, a first dispersing agent and a first adhesive agent, and the second negative electrode active material layer further includes a second conductive agent, a second dispersing agent and a second adhesive agent.

The first conductive agent and the second conductive agent are the same or different, the first dispersing agent and the second dispersing agent are the same or different, and the first adhesive agent and the second adhesive agent are the same or different.

According to the present application, a mass percentage of each component in the first negative electrode active material layer is:

90 wt % to 98.99 wt % of the first negative electrode active material, 0.01 wt % to 2 wt % of the first conductive agent, 0.5 wt % to 3 wt % of the first dispersing agent, and 0.5 wt % to 5 wt % of the first adhesive agent.

Exemplarily, the first conductive agent has the mass percentage of 0.01 wt %, 0.5 wt %, 1 wt %, 1.5 wt %, 2 wt %; the first adhesive agent has the mass percentage of 0.5 wt %, 1 wt %, 2 wt %, 4 wt %, 5 wt %, the first dispersing agent has the mass percentage of 0.5 wt %, 1 wt %, 1.5 wt %, 2.5 wt %, 3 wt %, and the first negative electrode active material has the mass percentage of 98.99 wt %, 97.5 wt %, 95.5 wt %, 92 wt %, 90 wt %.

According to the present application, a mass percentage of each component in the second negative electrode active material layer is:

90 wt % to 98.99 wt % of the second negative electrode active material, 0.01 wt % to 2 wt % of the second conductive agent, 0.5 wt % to 3 wt % of the second dispersing agent, 0.5 wt % to 5 wt % of the second adhesive agent.

Exemplarily, the second conductive agent has the mass percentage of 0.01 wt %, 0.5 wt %, 1 wt %, 1.5 wt %, 2 wt %; the second adhesive agent has the mass percentage of 0.5 wt %, 1 wt %, 2 wt %, 4 wt %, 5 wt %, the second dispersing agent has the mass percentage of 0.5 wt %, 1 wt %, 1.5 wt %, 2.5 wt %, 3 wt %, and the second negative electrode active material has the mass percentage of 98.99 wt %, 97.5 wt %, 95.5 wt %, 92 wt %, 90 wt %.

The first conductive agent and the second conductive agent are the same or different, and are respectively and independently selected from at least one of conductive carbon black, acetylene black, ketjen black, conductive graphite, conductive carbon fiber, carbon nanotube, metal powder and carbon fiber.

The first adhesive agent and the second adhesive agent are the same or different, and are respectively and independently selected from at least one of styrene-butadiene rubber (SBR), polyacrylic acid, polyurethane, polyvinyl alcohol, polyvinylidene fluoride (PVDF), and copolymer of vinylidene fluoride-fluorinated olefins.

The first dispersing agent and the second dispersing agent are the same or different, and are respectively and independently selected from at least one of sodium carboxymethyl cellulose (CMC-Na) and lithium carboxymethyl cellulose (CMC-Li).

The present application further provides a preparation method of the above-mentioned negative electrode plate, and the method includes the following steps:

1) preparing slurry forming a first negative electrode active material layer and slurry forming a second negative electrode active material layer, respectively;

2) coating a surface of a negative electrode current collector with the slurry forming the first negative electrode active material layer and the slurry forming the second negative electrode active material layer by using a double-layer coating machine, to prepare the negative electrode plate.

Exemplarily, step 1) includes the following steps:

(1-1) mixing a first graphite with a first silicon material, adding a specific proportion of a first conductive agent, a first adhesive agent and a first dispersing agent, and then blending them with water to prepare negative electrode slurry A with an appropriate solid content;

(1-2) mixing a second graphite with a second silicon material (it can be omitted if no second silicon material), adding a specific proportion of a second conductive agent, a second adhesive agent and a second dispersing agent, and then blending them with water to prepare negative electrode slurry B with an appropriate solid content.

Exemplarily, step 2) includes the following steps:

coating the negative electrode current collector with the negative electrode slurry A by using the double-layer coating machine, drying, and coating the negative electrode slurry A with the negative electrode slurry B, drying, rolling, slitting, and making electrode to prepare the negative electrode plate.

The present application further provides a lithium-ion battery, including the above-mentioned negative electrode plate.

According to the present application, the lithium-ion battery further includes a positive electrode plate, an electrolyte solution, a separator and an aluminum laminated film.

According to the present application, a positive electrode active material in the positive electrode plate is lithium cobaltate.

The beneficial effects of the present application are that:

(1) Compared with an existing negative electrode double-layer coating structure with silicon-doped negative electrode in a bottom layer and graphite negative electrode both in top and bottom layers, the negative electrode plate of the present application may further increase a silicon doping amount in the negative electrode (increase the capacity per gram of the negative electrode) without losing the cycle performance, so as to achieve a purpose of improving the energy density of the battery.

(2) Compared with a conventional structure of single-layer coating of negative electrode with the same proportion of silicon doping amount, the negative electrode plate of the present application may improve the cycle performance of the battery without losing the energy density.

### BRIEF DESCRIPTION OF THE DRAWINGS

FIG. 1 is a schematic structural diagram of a negative electrode plate according to the present application.

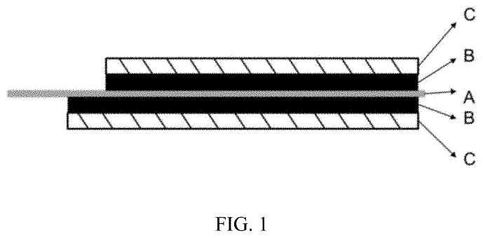

A represents a negative electrode current collector, B represents a first negative electrode active material layer, and C represents a second negative electrode active material layer.

### DETAILED DESCRIPTION OF THE EMBODIMENTS

The present application will be further described in detail with reference to specific embodiments hereinafter. It should be understood that the following embodiments only illustrate and explain the present application exemplarily, and should not be interpreted as limitations of the protection scope of the present application. All technologies implemented based on the foregoing contents of the present application fall within the scope of the present application is intended to protect.

Experimental methods used in the following examples are conventional methods unless otherwise specified; and reagents, materials, or the like, used in the following examples can be obtained from commercial sources unless otherwise specified.

In the description of the present application, it should be noted that the terms “first”, “second”, and the like, are only used for descriptive purposes, and do not indicate or imply relative importance.

The OI values of a first graphite and a second graphite used in the following examples are measured by X-ray diffraction (XRD).

The ultimate compacted densities of the first graphite and second graphite used in the following examples are determined by preparing negative electrode plates with different compacted densities, rolling these negative electrode plates and taking a photograph with SEM to observe integrity of particles, assembling the battery and testing performance.

### Example 1

(1) Preparation of Negative Electrode Plate

(1-1) Preparation of Slurry of a First Negative Electrode Active Material (Denoted as Negative Electrode Slurry A)

A first graphite (artificial graphite, OI value is 5.8, ultimate compacted density is 1.8 g/cm³, and D50 is 14.6 μm), a first silicon material (silicon oxide, SiOₓ, x=1, and D50 is 6.2 μm), a first conductive agent (conductive carbon black and carbon nanotubes with a mass ratio of 1:1), a first adhesive agent (styrene-butadiene rubber) and a first dispersing agent (CMC-Na) are mixed according to a mass ratio of 88:8:1:1:2, and then water is added to stir to prepare negative electrode slurry A.

(1-2) Preparation of Slurry of a Second Negative Electrode Active Material (Denoted as Negative Electrode Slurry B)

A second graphite (artificial graphite, OI value is 3.5, ultimate compacted density is 1.7 g/cm³, D50 is 15.2 μm, and a thickness of hard carbon coating is 5 nm), a second silicon material (silicon oxide, SiOₓ, x=1, and D50 is 6.2 μm), a second conductive agent (conductive carbon black and carbon nanotubes with a mass ratio of 1:1), a second adhesive agent (styrene-butadiene rubber) and a second dispersing agent (CMC-Na) are mixed according to a mass ratio of 95:2:0.5:1:1.5, and then water is added to stir to prepare negative electrode slurry B.

(1-3) Then, a double-layer coating device is used to coat the negative electrode slurry A and the negative electrode slurry B on a negative electrode current collector at one time (double-sided coating) according to a mass ratio of 5:5, drying and rolling (compacted density p=1.8 g/cm³). The experimental results show that when a negative electrode double-layer coating structure is adopted, if a difference of the ultimate compacted density between the first graphite and the second graphite does not exceed 0.15 g/cm³, a rolling compacted density of the negative electrode plate may adopt the larger ultimate compacted density of the two graphites (at this time, graphite particles with smaller ultimate compacted density will not be destroyed), slitting and making electrode to prepare the negative electrode plate. Each thickness of a first negative electrode active material layer (single side) and a second negative electrode active material layer (single side) in the negative electrode plate is 90 μm; and a mixing proportion of silicon material in a whole negative electrode active material is 5 wt %.

(2) Preparation of Positive Electrode Plate

A positive electrode active material (lithium cobaltate), a conductive agent (conductive carbon black) and an adhesive agent (PVDF) are mixed according to a mass ratio of 7.8:1.1:1.1, and then N-methylpyrrolidone is added to stir and disperse to prepare positive electrode slurry. Then the positive electrode slurry is coated on a positive electrode current collector (double-sided coating), drying, rolling, slitting, and making electrode to prepare the positive electrode plate.

(3) Preparation of Battery

The negative electrode plate prepared in the first step and the positive electrode plate prepared in the second step are wound with a separator to make a jelly roll, and then packaged with an aluminum laminated film to make a battery. Then, electrolyte injection, storing, formation, secondary packaging, sorting and other processes are performed. Finally, the energy density and cycle performance of the battery are tested.

A preparation environment temperature of the electrode material should be maintained at 20° C. to 30° C., and humidity ≤40% RH.

The devices used in the preparation of the electrode material includes: a blender, a coating machine, a roller press, a slitting machine, a plate manufacturing machine, an ultrasonic spot welding machine, a top side sealing machine, a code spraying machine, a film pasting machine, an electrolyte injection machine, a formation cabinet, a cold press, a sorting cabinet, a vacuum oven, etc.

### Examples 2-9 and Comparative Examples 1-5

The preparation of lithium-ion batteries of Examples 2-9 and comparative examples 1-5 are the same as that of Example 1, and differences are only in selection of graphite, feeding ratio of each component in the negative electrode slurry, and coating structure, as shown in Table 1 for details. A surface of one side of a negative electrode current collector of a negative electrode plate in comparative examples 2-4 is coated with only one layer of slurry, and a thickness of a negative electrode active material layer formed by the slurry is 180 μm. A surface of one side of a negative electrode current collector of a negative electrode plate in other examples and comparative examples is coated with two layers of slurry, and a sum of thicknesses of two layers of negative electrode active material layers formed by the two layers of slurry is 180 μm.

### Examples 10-12

The preparation method of lithium-ion battery of Example 10 is basically the same as that of Example 1. The difference of Example 10 is only that a first silicon material and a second silicon material are different from those of Example 1. The first silicon material and the second silicon material of Example 10 are carbon-coated elemental silicon (D50=100 nm, thickness of carbon coating of 5 nm). The difference of Examples 11-12 is only that a thickness of a hard carbon coating of a second graphite material is different from that of Example 1. The thickness of the hard carbon coating of the second graphite material of Example 11 is 15 nm, and the thickness of the second graphite coating of Example 12 is 20 nm.

Performance testing and energy density testing of batteries of aforementioned Examples and comparative examples are performed, the testing process is as follows:

1) Energy Density Test:

A thickness (unit: mm) of a finished battery is measured by a 600 g PPG thickness gauge, and a length and width (unit: mm) are determined by the model of the battery and considered as fixed values. Energy density (ED, unit Wh/L)=sorting discharge energy value (Wh)/battery thickness/battery length/battery width*1000.

2) Cycle Performance Test and Battery Thickness Expansion Rate Test:

Cycle performance of the battery is tested by a LAND test cabinet. The battery is charged and discharged at a rate of 0.7 C/0.5 C in a voltage range of 4.45 V to 2.75 V at 25° C. Before the cycle, an initial half-electric (3.87 V) thickness of the battery is measured by the 600 g PPG thickness gauge, and then a full-electric thickness of the battery is measured every 50 cycles.

Capacity retention (%)=discharge capacity (mAh) for the current cycle/discharge capacity (mAh) of the first cycle*100%.

Battery thickness expansion rate (%)=battery thickness (mm) for current cycle/initial thickness (mm)*100%.

The test results are shown in Table 2.

TABLE 1

| | First graphite | | | Second graphite | | | | |
|---|---|---|---|---|---|---|---|---|
| | | | Ultimate | | | Ultimate | Mass ratio of | Mass ratio of |
| | D50 | | compacted | D50 | | compacted | each | each |
| | diameter/ | OI | density/ | diameter/ | OI | density/ | substance in | substance in |
| | μm | value | g · cm⁻³ | μm | value | g · cm⁻³ | the slurry A | the slurry B |
| Example 1 | 14.6 | 5.8 | 1.8 | 15.2 | 3.5 | 1.7 | 88:8:1:1:2 | 95:2:0.5:1:1.5 |
| Example 2 | 14.6 | 5.8 | 1.8 | 15.2 | 3.5 | 1.7 | 90:6:1:1:2 | 95:2:0.5:1:1.5 |
| Example 3 | 14.6 | 5.8 | 1.8 | 15.2 | 3.5 | 1.7 | 92:4:1:1:2 | 95:2:0.5:1:1.5 |
| Example 4 | 14.6 | 5.8 | 1.8 | 15.2 | 3.5 | 1.7 | 88:8:1:1:2 | 94:3:0.5:1:1.5 |
| Example 5 | 14 | 6.4 | 1.83 | 15.2 | 3.5 | 1.7 | 88:8:1:1:2 | 95:2:0.5:1:1.5 |
| Example 6 | 14.6 | 5.8 | 1.8 | 15.2 | 3.5 | 1.7 | 84:12:1:1:2 | 95:2:0.5:1:1.5 |
| Example 7 | 14.6 | 5.8 | 1.8 | 15.2 | 3.5 | 1.7 | 88:8:1:1:2 | 92:5:0.5:1:1.5 |
| Example 8 | 14.2 | 3.1 | 1.58 | 15.2 | 3.5 | 1.7 | 88:8:1:1:2 | 95:2:0.5:1:1.5 |
| Example 9 | 14.6 | 5.8 | 1.8 | 15.2 | 3.5 | 1.7 | 88:8:1:1:2 | 97:0:0.5:1:1.5 |
| Example 10 | 14.6 | 5.8 | 1.8 | 15.2 | 3.5 | 1.7 | 88:8:1:1:2 | 97:0:0.5:1:1.5 |
| Example 11 | 14.6 | 5.8 | 1.8 | 15.2 | 3.5 | 1.7 | 88:8:1:1:2 | 95:2:0.5:1:1.5 |
| Example 12 | 14.6 | 5.8 | 1.8 | 15.2 | 3.5 | 1.7 | 88:8:1:1:2 | 95:2:0.5:1:1.5 |
| Comparative | 14.6 | 5.8 | 1.8 | 15.2 | 3.5 | 1.7 | 96:0:1:1:2 | 95:2:0.5:1:1.5 |
| Example 1 | | | | | | | | |
| Comparative | 14.6 | 5.8 | 1.8 | / | / | / | 91:5:1:1:2 | / |
| Example 2 | | | | | | | | |
| Comparative | / | / | / | 15.2 | 3.5 | 1.7 | / | 95:2:0.5:1:1.5 |
| Example 3 | | | | | | | | |
| Comparative | 14.6 | 5.8 | 1.8 | / | / | / | 88:8:1:1:2 | / |
| Example 4 | | | | | | | | |
| Comparative | 15.2 | 3.5 | 1.7 | 14.6 | 5.8 | 1.7 | 95:2:0.5:1:1.5 | 88:8:1:1:2 |
| Example 5 | | | | | | | | |

Remarks: Mass ratio of each substance in the slurry A refers to the mass ratio of the first graphite, the first silicon material, the first conductive agent, the first adhesive agent and the first dispersing agent; mass ratio of each substance in the slurry B refers to the mass ratio of the second graphite, the second silicon material, the second conductive agent, the second adhesive agent and the second dispersing agent.

TABLE 2

| | | Capacity | Thickness |
|---|---|---|---|
| | Energy | retention | expansion rate of |
| | density | for 400 | the battery for |
| | (Wh/L) | cycles | 400 cycles |
| Example 1 | 780 | 92% | 8% |
| Example 2 | 777 | 93% | 7.5% |
| Example 3 | 774 | 94% | 6.9% |
| Example 4 | 782 | 90% | 8.6% |
| Example 5 | 787 | 90% | 8.2% |
| Example 6 | 786 | 80% | 10.3% |
| Example 7 | 785 | 85% | 9.9% |
| Example 8 | 760 | 95% | 7.1% |
| Example 9 | 777 | 92% | 7.6% |
| Example 10 | 782 | 89% | 9% |
| Example 11 | 777 | 93% | 8% |
| Example 12 | 770 | 94% | 8% |
| Comparative | 768 | 96% | 4.2% |
| Example 1 | | | |
| Comparative | 780 | 86% | 10% |
| Example 2 | | | |
| Comparative | 751 | 96.5% | 4.9% |
| Example 3 | | | |
| Comparative | 789 | 82% | 9.5% |
| Example 4 | | | |
| Comparative | 780 | 88% | 8.6% |
| Example 5 | | | |

By comparing Examples 1-3, comparative example 1 and example 6 from the above table, it can be known that in Examples 1-3, when a proportion of silicon-oxygen material in the negative electrode slurry A to a total mass of the first negative electrode active material layer ranges from 1 wt % to 9 wt % and gradually decreases, for every 2 wt % reduction, the energy density of the battery is reduced by about 3 Wh/L, and the cycle capacity retention is increased by about 1%. In Example 6, a proportion of silicon oxide material in the negative electrode slurry A to the total mass of the first negative electrode active material layer is 12 wt %, and the energy density of the battery is increased by 6 Wh/L compared with Example 1, but the capacity retention is sharply reduced by 12%. The negative electrode slurry A of comparative example 1 has no silicon oxide material, although the capacity retention is increased by 4%, the energy density of the battery is decreased by 12 Wh/L.

By comparing Example 1, Example 4, Example 7 and Example 9 from the above table, it can be known that in Example 1 and Example 4, when a proportion of silicon oxide material in the negative electrode slurry B to the total mass of the second negative electrode active material layer changes from 1 wt % to 3 wt %, the energy density of the battery is negatively correlated with the cycle capacity retention, and slight changes. In Example 7, a proportion of silicon oxide material in the negative electrode slurry B to the total mass of the second negative electrode active material layer is 5 wt %, and the energy density of the battery is increased by 5 Wh/L compared with Example 1, but the capacity retention is sharply reduced by 7%. The negative electrode slurry B of Example 9 has no silicon oxide material, although the energy density is reduced by 3 Wh/L compared with Example 1, the capacity retention is increased by 2%.

By comparing Example 1, Example 5 and Example 8 from the above table, when the ultimate compacted density of the first graphite is increased to 1.83 g/cm³, the overall compacted density of the negative electrode plate can be increased to 1.83 g/cm³, so the energy density of Example 5 is increased by 7 Wh/L compared with that of Example 1. Further, because of the higher OI value of the graphite, the capacity retention is reduced by 2%. When the ultimate compacted density of the first graphite in Example 8 is reduced to 1.58 g/cm³, the overall compacted density of the negative electrode plate is reduced to the compacted density 1.7 g/cm³ of the second graphite. The capacity retention of Example 8 is increased by 3% compared with that of Example 1, but the energy density is reduced by 20 Wh/L compared with that of Example 1.

By comparing Example 1 with comparative example 2, the silicon-oxygen mixing proportions of the two negative electrode plates are the same, both accounting for 5 wt % of the negative electrode active material, and the energy densities of the batteries are the same, but in the single-layer coating structure of negative electrode in comparative example 2, the battery cycle capacity retention is 6% lower than that of Example 1.

By comparing Example 1 with comparative example 3, comparative example 3 is equivalent to a single-layer coating structure coated only with the slurry B, in which the negative electrode compacted density is 1.7 g/cm³, and the silicon-oxygen mixing proportion is 2%. Although its capacity retention for 400 cycles is 4.5% higher than that of Example 1, the energy density is reduced by 29 Wh/L.

By comparing Example 1 with comparative example 4, comparative example 4 is equivalent to a single-layer coating structure coated only with the slurry A, in which the negative electrode compacted density is 1.8 g/cm³, and the silicon-oxygen mixing proportion is 8%. Although its energy density is 9 Wh/L higher than that of Example 1, the capacity retention for 400 cycles is reduced by 10%.

By comparing Example 1 with comparative example 5, comparative example 5 is equivalent to changing a position of the first negative electrode active material layer and the second negative electrode active material layer of Example 1, the energy density remains unchanged, but the capacity retention for 400 cycles decreases by 4%.

By comparing Example 1 with Example 10, Example 10 uses carbon-coated elemental silicon, although the energy density is increased by 2 Wh/L, the capacity retention for 400 cycles is reduced by 3%, and the thickness expansion rate of the battery for 400 cycles is increased by 1%.

By comparing Examples 11-12 with Example 1, the thicknesses of the hard carbon coatings of the second graphite in Examples 11-12 are increased, which leads to the decrease of initial Coulombic efficiency of the second graphite material, and the larger the coating amount, the more the initial Coulombic efficiency decreases. Therefore, the energy density of Examples 11-12 is lower than that of Example 1, but the capacity retention is higher than that of Example 1.

The above description summarizes the characteristics of several embodiments, which enables people with general knowledge in the technical field to better understand the various aspects of the present application. Those with general knowledge in the technical field can easily use the present application as a basis to design or modify other compositions in order to achieve the same purpose and/or achieve the same advantages as the embodiments applied here. It is also understandable to those with general knowledge in the technical field that these equal examples do not depart from the spirit and scope of the present application, and they may make various changes, substitutions and modifications or the present application without departing from the spirit and scope of the present application. Although the methods disclosed in the present application have been described by reference to specific operations performed in specific order, it should be understood that these operations can be combined, subdivided or reordered to form equivalent methods without departing from the instructions of the present application. Therefore, unless otherwise indicated herein, the order and grouping of operations is not a limitation to the present application.

The implementations of the present application have been illustrated above. However, the present application is not limited to the above-mentioned implementations. Any modification, equivalent replacement, improvement, or the like, made within the spirit and the principle of the present application shall fall within the protection scope of the present application.

What is claimed is:

1. A negative electrode plate, comprising:
a negative electrode current collector, a first negative electrode active material layer, and a second negative electrode active material layer, wherein the first negative electrode active material layer is disposed on a surface of the negative electrode current collector, and the second negative electrode active material layer is disposed on a surface of the first negative electrode active material layer,
wherein the first negative electrode active material layer comprises a first negative electrode active material, and the first negative electrode active material comprises a first graphite and a first silicon material;
the second negative electrode active material layer comprises a second negative electrode active material, and the second negative electrode active material comprises a second graphite; and
an OI value of the first graphite is greater than an OI value of the second graphite, wherein OI=I₀₀₄/I₁₁₀, I₀₀₄ denotes a peak intensity of a 004 crystal plane of graphite during X-ray diffraction, and I₁₁₀ denotes a peak intensity of a 110 crystal plane of graphite during X-ray diffraction.

2. The negative electrode plate according to claim 1, wherein the second negative electrode active material further comprises a second silicon material; and a mass proportion of the first silicon material in the first negative electrode active material layer is greater than a mass proportion of the second silicon material in the second negative electrode active material layer.

3. The negative electrode plate according to claim 2, wherein the mass proportion of the first silicon material in the first negative electrode active material layer ranges from 3 wt % to 9 wt %, and the mass proportion of the second silicon material in the second negative electrode active material layer ranges from 1 wt % to 3 wt %.

4. The negative electrode plate according to claim 2, wherein the mass proportion of the first silicon material in the first negative electrode active material layer ranges from 3 wt % to 9 wt %, and the mass proportion of the second silicon material in the second negative electrode active material layer is 0.

5. The negative electrode plate according to claim 2, wherein a sum of a mass of the first silicon material and that of the second silicon material accounts for 1 wt % to 9 wt % of a total mass of the first negative electrode active material layer and the second negative electrode active material layer.

6. The negative electrode plate according to claim 1, wherein a ratio of a thickness of the first negative electrode active material layer to a thickness of the second negative electrode active material layer ranges from 1:9 to 9:1.

7. The negative electrode plate according to claim 1, wherein a thickness of the first negative electrode active material layer ranges from 20 μm to 180 μm.

8. The negative electrode plate according to claim 1, wherein a thickness of the second negative electrode active material layer ranges from 20 μm to 180 μm.

9. The negative electrode plate according to claim 1, wherein the OI value of the first graphite ranges from 5 to 7, and the OI value of the second graphite ranges from 3 to 5.

10. The negative electrode plate according to claim 1, wherein the first silicon material is selected from one or more of elemental silicon, silicon oxide, silicon carbon composite, and silicon alloy, wherein coating treatment is performed on the first silicon material, and a coating comprises carbon material or at least one oxide of Al, Si, Ti, Mn, V, Cr, Co or Zr.

11. The negative electrode plate according to claim 10, wherein the first silicon material is carbon-coated elemental silicon, the carbon-coated elemental silicon has a median particle diameter D50 ranging from 0.01 μm to 1 μm and a carbon-coated layer has a thickness ranging from 1 nm to 10 nm.

12. The negative electrode plate according to claim 2, wherein the second silicon material is selected from one or more of elemental silicon, silicon oxide, silicon carbon composite, and silicon alloy, wherein coating treatment is performed on the second silicon material, and a coating comprises carbon material or at least one oxide of Al, Si, Ti, Mn, V, Cr, Co or Zr.

13. The negative electrode plate according to claim 12, wherein the second silicon material is carbon-coated elemental silicon, the carbon-coated elemental silicon has a median particle diameter D50 ranging from 0.01 μm to 1 μm and a carbon-coated layer has a thickness ranging from 1 nm to 10 nm.

14. The negative electrode plate according to claim 10, wherein the silicon oxide has a median particle diameter D50 ranging from 1 μm to 10 μm.

15. The negative electrode plate according to claim 1, wherein the first graphite has an ultimate compacted density ranging from 1.75 g/cm³ to 1.83 g/cm³; and the second graphite has an ultimate compacted density ranging from 1.65 g/cm³ to 1.75 g/cm³.

16. The negative electrode plate according to claim 1, wherein the first graphite has a median particle diameter D50 ranging from 10 μm to 20 μm; and the second graphite has a median particle diameter D50 ranging from 10 μm to 20 μm.

17. The negative electrode plate according to claim 1, wherein a surface of the second graphite is coated with hard carbon, and a hard carbon coating has a thickness ranging from 5 nm to 20 nm.

18. The negative electrode plate according to claim 1, wherein the first negative electrode active material layer further comprises a first conductive agent, a first dispersing agent and a first adhesive agent; and
a mass percentage of each component in the first negative electrode active material layer is: 90 wt % to 98.99 wt % of the first negative electrode active material, 0.01 wt % to 2 wt % of the first conductive agent, 0.5 wt % to 3 wt % of the first dispersing agent, and 0.5 wt % to 5 wt % of the first adhesive agent.

19. The negative electrode plate according to claim 1, wherein the second negative electrode active material layer further comprises a second conductive agent, a second dispersing agent and a second adhesive agent; and
a mass percentage of each component in the second negative electrode active material layer is: 90 wt % to 98.99 wt % of the second negative electrode active material, 0.01 wt % to 2 wt % of the second conductive agent, 0.5 wt % to 3 wt % of the second dispersing agent, 0.5 wt % to 5 wt % of the second adhesive agent.

20. A lithium-ion battery, comprising: a negative electrode plate,
wherein the negative electrode plate comprises: a negative electrode current collector, a first negative electrode active material layer, and a second negative electrode active material layer, wherein the first negative electrode active material layer is disposed on a surface of the negative electrode current collector, and the second negative electrode active material layer is disposed on a surface of the first negative electrode active material layer,
wherein the first negative electrode active material layer comprises a first negative electrode active material, and the first negative electrode active material comprises a first graphite and a first silicon material;
the second negative electrode active material layer comprises a second negative electrode active material, and the second negative electrode active material comprises a second graphite; and
an OI value of the first graphite is greater than an OI value of the second graphite, wherein OI=I₀₀₄/I₁₁₀, I₀₀₄ denotes a peak intensity of a 004 crystal plane of graphite during X-ray diffraction, and I₁₁₀ denotes a peak intensity of a 110 crystal plane of graphite during X-ray diffraction.
